(19) United States
(12) Patent Application Publication
(10) Pub. No.: US 2004/0027496 A1
(43) Pub. Date: Feb. 12, 2004

(54) Simultaneous multi-language motion picture playback system

(76) Inventor: Steven A. Morales, Stockton, CA (US)

Correspondence Address: CAHIL, von HELLENS & GLAZER P.L.C., 155 Park One, 2141 East Highland Avenue, Phoenix, AZ, 85016, US

(21) Appl. No.: 10/438,449

(22) Filed: May 15, 2003

Related U.S. Application Data
(60) Provisional application No. 60/381,031, filed on May 15, 2002.

(51) Int. Cl. H04N 3/22; H04N 3/26

(52) U.S. Cl. 348/745

(57) ABSTRACT

A movie projection system includes a film projector for projecting moving images of a film while broadcasting the film sound track in two or more languages simultaneously to different film viewers who view the film at the same theater. A time code reader detects time code signals recorded on the film and derives sync signals therefrom. First and second playback machines each receive the sync signals for generating first and second sound tracks, in first and second languages, respectively, each synchronized with the images recorded on the film. The first sound track is broadcast over the usual theater sound system, while the second sound track is transmitted to receivers worn by those viewers who speak the second language.

### CROSS REFERENCE TO RELATED APPLICATION

The present application relates to subject matter described in and claims priority to a provisional application entitled “SIMULTANEOUS MULTI-LANGUAGE MOTION PICTURE PLAYBACK SYSTEM,” assigned Serial No. 60-381,031 and assigned a filing date of May 15, 2002, and describing an invention made by the present inventor.

### BACKGROUND OF THE INVENTION

1. Field of the Invention

The present invention relates generally to audio systems for motion picture theaters, and more particularly, to an audio system for a movie projector that allows for playback of the audio track in more than one language.

2. Description of the Related Art

The United States is clearly becoming a nation of many languages. Unfortunately, if a person in the United States is not fluent in the English-language, such person can not always enjoy some of the same activities as English-speaking people—especially when it comes to movies and related forms of entertainment.

Over the years, movies and sound have come almost full circle. Initially, pianist, organist, and even live orchestras accompanied films to enhance the viewing experience. In 1926, Warner Brothers produced a film called “Don Juan” with only music as the sound track. The “Jazz Singer”, introduced in 1927, was the first movie to include both voice and music within the sound track, and used a wax record and a Vitaphone. The earliest of “talking pictures” used a film projector and a record player. Once the film started, an operator standing nearby the film projector and record player would start the record player and try, as best as possible, to keep the two in sync. As technology improved over the years, a sound track was optically placed on the video film track, and the external sound machine (i.e., record player) was no longer needed. Sound for movies was activated by a light passing over the sound track on the film and sent through amplifiers and speakers for reproduction in the movie theater.

The movie industry has constantly sought better sound, and over the years, shifted from monaural sound to stereo sound; however, the stereo sound track was still optically recorded onto, and recovered from, the video film. Later, external “playback devices”, or sound machines, were combined with movie projectors to make use of more advanced, and better quality sound, on recorded on CDs and the like. These “playback devices” were synced with “time codes” on the film. External “playback devices”, such as those available from Digital Theatre Systems of Agoura Hills, Calif., play two CDs with the sound for movies; if the movie is short, only one CD is required. This machine, quite often, is made with a third CD drive in order to sync the upcoming movie preview sound. The use of CDs allows for much better quality sound, and almost perfect syncing between film and sound, even though the sound is once again generated on an external device.

Today, theaters use either external playback devices or sound recorded upon the actual film in order to generate the sound track to be broadcast in the movie theater. Currently, most movie theaters show films by using 1) a film projection unit; 2) a sound reader; and 3) a time code reader for an external playback machine. Some sound movie houses do not use an external playback machine, but rely solely on the sound recorded on the film, as read by the aforementioned sound reader. Film is fed into the projection unit. As the film runs, the sound reader attached to the film projection unit reads the sound track from the film. The time code reader can be attached to the film projection unit to activate the external playback device; the time code reader reads dots and dashes that are placed on the film in order to sync the images on the film with the sounds being derived from the external playback machine. Alternatively, the sound track can be created with external playback devices via a time code reader used to activate such external playback devices. However, current technology only allows for sound to come from the film itself, or from an external playback device, and not from both sources at one time; moreover, the sound track recorded on the film is in the same language as the sound track generated by the external playback device. While film producers continue to embed sound tracks on the film itself, new, higher quality “playback devices” are now used to provide a greatly enhanced listening experience. Typically, the external playback device is the primary source for sound, while the sound track embedded on the film itself is used as a back-up source, if needed. Currently, the sound track embedded on the film itself can accommodate only one language in sync with the external “playback device.”

While movies have made tremendous strides in the quality of sound that can be reproduced within a movie theater, movies continue to only accommodate one language per film, and in the United States, that language is typically English. However, many people living in the United States do not speak English well. The United States Census for the year 2000 reported that there were approximately 35 million Hispanics in the U.S. Many of these people do not have a great command of the English language. Indeed, it is not unusual among Spanish-speaking families who attend movie theaters for one of the children to translate words for the other family members present.

Because of existing technology and current film systems, theaters either show a movie in English, use foreign sub-titles, or decide to show a foreign language film in another language for the entire audience. Sub-titles are difficult to use and distract from the viewing experience. On the other hand, dedicating a total theater auditorium for a foreign-language film can be costly. Years ago, there were many Spanish Cinemas throughout California that played foreign films in Spanish, or late-release American films with sub-titles. Sub-titles can be troubling for most people to use while watching a film, and with Spanish films on videotape becoming more and more popular, the aforementioned Spanish cinemas have faded away.

Until now, movie theaters have not broadcast movie film sound tracks in multiple languages at the same time within a movie theater. With the world becoming more and more multi-lingual, there is a tremendous need for a movie film system compatible with existing movie technology, but which permits members of the same viewing audience to hear more than one language. For years, Spanish-speaking families in the United States had to wait months in order to enjoy a new release movie in Spanish when the video or DVD came out with Spanish-language dubbing. Ironically, many of these new-release movies were being released in Mexico, Central and South America and Spain, in Spanish, and at virtually the same time that such movies were being released in the United States in English.

For example, the movie Harry Potter was first released in English in December 2001, but Spanish-speaking families in the U.S. were not able to be able to enjoy it until May 28, 2002 when the DVD with Spanish option was scheduled for introduction. Interestingly, in regard to most new release movies, the Spanish dubbed version is ready for shipment at the same time that the English versions are first shipped to theaters in the United States.

There are in use today systems for use by those who are hearing-impaired, including systems for amplifying the sound that is being broadcast over the theater's speaker system. Such systems for the hearing-impaired are generally attached to the aforementioned playback machine and broadcast the sound track in the same one language that is being performed by the sound system of the theater. These systems for the hearing-impaired are generally “closed” systems that require a set transmitter and a receiver that only work with each other. Again, these systems for the hearing-impaired have not been used in movie theaters to transmit a sound track in a language different from that simultaneously being broadcast over the speaker system of such movie theater.

Accordingly, it is an object of the present invention that allows theater-goers who do not speak English well to attend movie theaters showing English-language films and still enjoy the movie.

Another object of the present invention is to allow a number of different theater-goers within the same movie theater to simultaneously view the same movie images while hearing the movie sound track simultaneously in different languages.

Still another object of the present invention is to provide such a movie theater system that can be constructed as a combination of well-known, currently-available components at relatively little cost.

These and other objects of the present invention will become more apparent to those skilled in the art as the description thereof proceeds.

### SUMMARY OF THE INVENTION

Briefly described, and in accordance with a preferred embodiment thereof, the present invention relates to a movie projection system for projecting moving images of a film and for broadcasting a film sound track in at least two different languages simultaneously to film viewers located in the same viewing location, e.g., a movie theater. The movie projection system includes a film projection unit for projecting images recorded on the film, as well as a time code reader coupled to the film projection unit for detecting time code signals recorded on the film. The time code reader derives sync signals from the time code signals. These sync signals are provided to first and second playback machines, which may be of the conventional type used to play compact discs that contain the sound track of the film. The first playback machine generates a first sound track in a first language synchronized with the images recorded on the film, and the second playback machine generates a second sound track in a second, different, language that is likewise synchronized with the images recorded on the film. The second playback machine may be coupled directly to the time code reader for directly receiving the sync signals; alternatively, the second playback machine may be coupled to the time code reader via the first playback machine for receiving such sync signals.

A first transmission system is coupled to the first playback machine for transmitting the first sound track to at least a first film viewer who desires to hear the first sound track. This first transmission system may, for example, include a conventional DTS decoder, amplifier and theater speaker system used to broadcast an English-language sound track within the theater. A second transmission system is coupled to the second playback machine for transmitting the second sound track to a second set of film viewers who desire to hear the second sound track in the second language, for example, in Spanish. This second transmission system might include a wireless transmitter for transmitting a high frequency (e.g. radio frequency or optical) signal within the theater. This high frequency signal has a frequency that is above the range audible to humans and containing the second sound track embedded therein, as by amplitude modulation (AM) or frequency modulation (FM), for example. A wireless receiver is disposed proximate each of the second set of film viewers for receiving the high frequency signal. Each such wireless receiver derives the second sound track therefrom, and plays the second sound track audibly to each of the second set of film viewers, as within headphones worn by such viewers.

Alternatively, the second transmission system may incorporate a hard wired connection network coupled between the second playback machine and a signal port (e.g., a headphone jack) provided at each theater seat. Those film viewers wishing to listen to the second sound track simply plug in headphones to such signal ports to hear the second sound track in the second language.

The present invention also relates to an improved method of projecting moving images of a film while broadcasting a film sound track in at least two different languages simultaneously. The present method includes the steps of projecting images recorded on the film for simultaneous viewing by at least first and second film viewers located at the same location, such as a movie theater, while detecting the time code signals recorded on the film to derive sync signals therefrom. The method further includes the steps of generating a first sound track in a first language synchronized with the images recorded on the film, and generating a second sound track in a second language likewise synchronized with the images recorded on the film, and wherein the second language differs from the first language. In addition, the present method includes the steps of transmitting the first sound track to the first film viewer, and transmitting the second sound track to the second film viewer. Preferably, the first sound track is generated by playing a first compact disc recorded in the first language, and the second sound track is generated by playing a second compact disc recorded in the second language. In the preferred form of the invention, the first sound track is transmitted to the first film viewer by amplifying the first sound track and driving audio speakers installed at the viewing location with the amplified first sound track. The second sound track can be conveyed to the second film viewer by using a wireless transmitter and receiver, or by hard wiring the second sound track over a hard wired connection to a signal port provided at each viewer's theater seat. In either case, the second film viewer wears headphones to hear the second sound track in the second language.

### BRIEF DESCRIPTION OF THE DRAWINGS

FIG. 1 is a block diagram showing a first embodiment of the present invention wherein the second playback machine used to generate the second (foreign language) sound track receives sync signals indirectly via the first playback machine.

FIG. 2 is a block diagram showing a first embodiment of the present invention wherein the first and second playback machines are both directly coupled to the time code reader for directly receiving the sync signals in parallel.

### DETAILED DESCRIPTION OF THE PREFERRED EMBODIMENTS

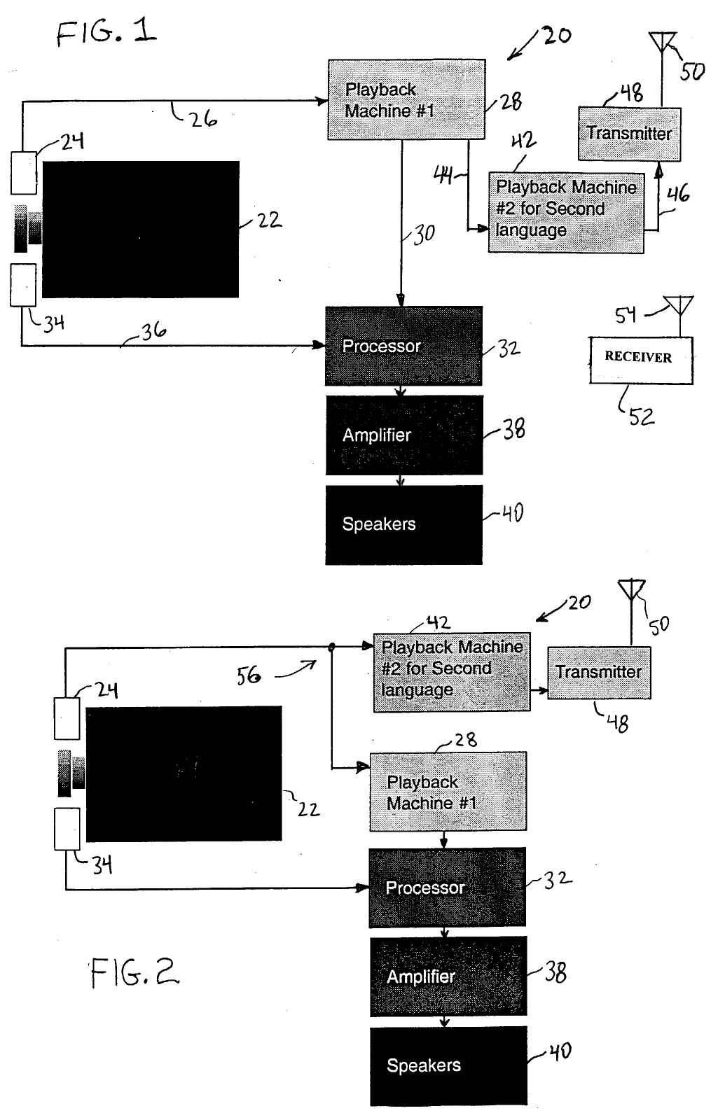

Referring to FIG. 1, a movie projection system constructed in accordance with a first preferred embodiment of the present invention is identified generally by reference numeral 20 and includes film projection unit 22 for projecting moving images recorded on a movie film (not shown) onto a display screen, for example, a movie theater film screen. As is known to those skilled in the art, the film has recorded thereon both images and time code signals for syncing a film sound track. A time code reader 24 is coupled to film projection unit 22 for detecting the time code signals recorded on the film and deriving the sync signals therefrom. These sync signals are provided to electrical conductor 26 and are received by a first playback machine 28. First playback machine 28 receives one or more compact discs and, in conjunction with the sync signals, generates a first sound track in a first language (e.g., English) synchronized with the images recorded on the film. The first sound track generated by first playback machine 28 is provided over signal line 30 to a sound processor 32, for example, a DTS signal processor. While not essential to the practice of the present invention, film projection unit 22 might also be coupled to audio reader 34 for reading the audio track recorded on the movie film itself. As mentioned above, the output of audio reader 34 may be used as a backup source of the audio track in the event that first playback machine 28 is not operating properly. The output of audio reader 34 is coupled by signal line 36 to another input of sound processor 32. Sound processor 32 can use either the coded output of first playback machine 28, or the output of audio reader 34, as the source of the first sound track. The output of processor 32, which may be a stereo or multi-channel output signal, is coupled to amplifier unit 38 which amplifies the first sound track and provides it to the theater speakers 40 for broadcast audibly to film viewers desiring to hear the sound track in the first language (i.e., English). Processor 32, amplifier 38 and speakers 40 may collectively be regarded as a first transmission system for transmitting the first sound track to the first group of film viewers who want to listen to the sound track in the first language.

Still referring to FIG. 1, a second playback machine 42 is coupled indirectly to time code reader 24 via first playback machine 28 and conductor 44. Second playback machine 42 receives one or more compact discs that have recorded thereon a sound track in the second language. Second playback machine 42 receives the sync signals via conductor 44 and is responsive thereto for generating a second sound track in a second language (e.g., Spanish) synchronized with the images recorded on the film. The output of second playback machine 42 is coupled by conductor 46 to transmitter 48; as shown in FIG. 1, transmitter 48 may include an antenna 50 for serving as a wireless transmitter. Transmitter 48 and antenna 50 transmit a high frequency signal, i.e., above the frequency range that is audible to humans, and preferably within a radio communication frequency band or an optical band of electromagnetic radiation. This high frequency signal contains, in coded or modulated form, the second sound track, and is broadcast throughout the theater. A film viewer desiring to hear the second sound track receives such high frequency signal by using receiver 52 equipped with antenna 54. Receiver 52, which might be a conventional AM/FM receiver, for example, receives the high frequency signal, derives the second sound track, and audibly plays the second sound track, in the second language, for such film viewer, preferably through a pair of headphones. Thus, movie projection system 20 broadcasts the film sound track in at least two different languages simultaneously to first and second film viewers located in the same theater at the same time. While transmitter 48 is illustrated as a radio frequency transmission system, optical (infrared) transmitter/receiver components could be used instead. Alternatively, transmitter 48 could be replaced by a hard wired connection coupled between second playback machine 42 and a headphone jack (not shown) provided at each seat in the theater. Those viewers desiring to hear the second sound track then simply plug in headphones to listen to such second sound track.

Turning to FIG. 2, the projection system shown therein is essentially identical to the projection system described above in regard to FIG. 1, except that the system of FIG. 2 directly couples second playback machine 42 to time code reader 24 in parallel with first playback machine 28. The system of FIG. 2 uses a split cable 56 from time code reader 24 leading directly to both first and second playback machines 28 and 42.

Another aspect of the present invention relates to a method of projecting moving images of a film and for broadcasting a film sound track in at least two different languages simultaneously to first and second film viewers located in the same location. Referring again to FIG. 1, the method includes the step of projecting images recorded on the film for simultaneous viewing by first and second film viewers, as by using projection unit 22. The method also includes the step of detecting the time code signals recorded on the film and deriving sync signals therefrom, as by using time code reader 24. The method further includes the steps of generating first and second sound tracks in first and second different languages, respectively, and synchronized with the images recorded on the film, e.g., in the manner performed by first and second playback machines 28 and 42. The first sound track is then transmitted to a first group of film viewers, as by using the theater speaker system (32, 38, 40), while transmitting the second sound track to a second group of film viewers, as by using the wireless transmitter/receiver system (48/52) illustrated in FIG. 1.

As described above, the new system makes use of the existing time code reader to activate first playback machine 28 to generate the first sound track in the first language, and uses the conventional sound processor 32, amplifier 38, and speakers 40 to play the first sound track. Moreover, the new system adds a second playback machine 42, responsive to the same time code from the film. However, second playback machine 42 has CD's containing the sound track in the second language. Second playback machine 42 has a separate transmitter (e.g., 48) to transmit the second language into the theater simultaneously with the first language of the standard speaker system, to allow both languages to be heard with one movie in the same room. People viewing the movie could either hear it in the first language (e.g., English) or could use a receiving device, such as a radio with headphones to receive the second language (e.g., Spanish). The second sound track (in the second language) can be transmitted with an AM or FM radio transmitter, or an infrared transmitter, and received by receivers in the form of standard AM/FM radios or infrared receivers. If desired, the transmission system for transmitting the second sound track could also be a closed system whereby the transmitter would only transmit to specific receivers that are only able to receive such transmission. Once again, transmitter 48 could be replaced by a hard wired connection coupled between second playback machine 42 and a headphone jack (not shown) provided at each seat in the theater.

Those skilled in the art will realize that the present invention is not limited to only two languages at a time, and that there could be numerous playback machines/transmission systems, all operating in synchronized fashion based upon the time code signals recorded on the film, to play numerous languages with a particular film. In such case, and assuming that the secondary sound track transmission system is effectively hard wired into the theater, as by providing each theater seat with built-in headphone jacks, the film user could operate a channel selector dial to select the channel having the sound track in the particular language desired.

While the preferred embodiment has been shown and described as including only a single time code reader for generating sync signals that are shared by the first and second playback machines, it may also be possible to interface a second time code reader on the film projection unit to separately derive sync signals to synchronize the second playback machine, if desired. Finally, while the preferred embodiment has been described as including first and second playback machines that are physically distinct from each other, another alternative approach would be to build one overall playback machine that could hold and play a larger number of CDs, or digital sound files, than is true for currently available playback machines, and to provide multiple output ports to output multiple sound tracks in different languages simultaneously from a single overall playback machine. In this instance, one may regard such single overall playback machine as effectively combining together two or more playback machines of the type already described above. In this regard, the portion of the overall playback machine that plays the first sound track could be regarded as the “first playback machine”, and the portion of the overall playback machine that plays the second sound track could be regarded as the “second playback machine”.

Those skilled in the art will now appreciate that a movie projection system has been described which allows theater-goers who do not understand English well to attend movie theaters showing English-language films and still enjoy the movie. Moreover, the described movie projection system allows a number of different theater-goers within the same movie theater to simultaneously view the same movie images while hearing the movie sound track simultaneously in different languages. It will also be appreciated that the described movie projection system can be constructed as a combination of well-known, currently-available components at relatively little cost.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

1. A movie projection system for projecting moving images of a film and for broadcasting a film sound track in at least two different languages simultaneously to first and second film viewers located in the same location, the film having recorded thereon both images and time code signals for syncing a film sound track, said movie projection system comprising in combination:
a. a film projection unit for projecting images recorded on the film;
b. a time code reader coupled to said film projection unit for detecting the time code signals recorded on the film and deriving sync signals therefrom;
c. a first playback machine coupled to said time code reader for receiving the sync signals, the first playback machine generating a first sound track in a first language synchronized with the images recorded on the film;
d. a first transmission system coupled to said first playback machine for transmitting the first sound track to the first film viewer;
e. a second playback machine coupled to said time code reader and responsive to the sync signals, the second playback machine generating a second sound track in a second language synchronized with the images recorded on the film, the second language differing from the first language; and
f. a second transmission system coupled to said second playback machine for transmitting the second sound track to the second film viewer.

2. The movie projection system recited by claim 1 wherein the first transmission system includes a sound processor for decoding sound signals generated by said first playback machine.

3. The movie projection system recited by claim 2 wherein the first transmission system includes an amplifier for amplifying decoded sound signals provided by said sound processor.

4. The movie projection system recited by claim 3 including a plurality of speakers coupled to said amplifier for playing the first sound track audibly to the first film viewer at the location.

5. The movie projection system recited by claim 1 wherein the second transmission system includes:
a. a wireless transmitter for transmitting a high frequency signal within the location, the high frequency signal having a frequency above the range that is audible by humans and containing the second sound track;
b. a wireless receiver disposed proximate the second film viewer for receiving the high frequency signal, deriving the second sound track therefrom, and playing the second sound track audibly to the second film viewer at the location.

6. The movie projection system recited by claim 1 wherein the location is a movie theater.

7. The movie projection system recited by claim 1 wherein said second playback machine is coupled to said time code reader by said first playback machine.

8. The movie projection system recited by claim 1 wherein said first playback machine plays compact discs of the first language.

9. The movie projection system recited by claim 8 wherein said second playback machine plays compact discs of the second language.

10. The movie projection system recited by claim 1 wherein said second transmission system includes:
a. a hard wired connection coupled between said second playback machine and a signal port provided on a seat proximate the second film viewer; and
b. headphones worn by the second film viewer and coupled to said signal port for conveying the second sound track to the ears of the second film viewer.

11. A method of projecting moving images of a film and for broadcasting a film sound track in at least two different languages simultaneously to first and second film viewers located in the same location, the film having recorded thereon both images and time code signals for syncing a film sound track, the method comprising the steps of:
a. projecting images recorded on the film for simultaneous viewing by first and second film viewers;
b. detecting the time code signals recorded on the film and deriving sync signals therefrom;
c. generating a first sound track in a first language synchronized with the images recorded on the film;
d. transmitting the first sound track to the first film viewer;
e. generating a second sound track in a second language synchronized with the images recorded on the film, the second language differing from the first language; and
f. transmitting the second sound track to the second film viewer.

12. The method recited by claim 11 wherein the step of generating the first sound track includes the step of playing a first compact disc recorded in the first language.

13. The method recited by claim 12 wherein the step of generating the second sound track includes the step of playing a second compact disc recorded in the second language.

14. The method recited by claim 11 wherein the step of transmitting the first sound track to the first film viewer includes the steps of amplifying the first sound track and driving audio speakers installed at the location with the amplified first sound track.

15. The method recited by claim 11 wherein the step of transmitting the second sound track to the second film viewer includes the steps of:
a. transmitting a high frequency signal within the location, the high frequency signal having a frequency above the range that is audible by humans and containing the second sound track;
b. receiving the high frequency signal proximate the second film viewer, deriving the second sound track therefrom, and playing the second sound track audibly to the second film viewer at the location.

16. The method recited by claim 11 wherein the location at which said method is performed is a movie theater.

17. The method recited by claim 11 wherein the step of transmitting the second sound track to the second film viewer includes the steps of:
a. conveying the second sound track over a hard wired connection to a signal port provided on a seat proximate the second film viewer; and
b. connecting headphones to the signal port for conveying the second sound track to the ears of the second film viewer.
